(19) United States
(12) Patent Application Publication
(10) Pub. No.: US 2005/0276982 A1
(43) Pub. Date: Dec. 15, 2005

(54) Magnetic leather floor and wall tiles

(76) Inventor: Stephen T. Manchee, Stouffville (CA)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/150,395

(22) Filed: Jun. 9, 2005

Related U.S. Application Data
(60) Provisional application No. 60/578,285, filed on Jun. 10, 2004.

(30) Foreign Application Priority Data
Jun. 11, 2004 (CA) 2,470,778

(51) Int. Cl. C11D 3/00

(52) U.S. Cl. 428/411.1

(57) ABSTRACT

A composite tile is provided having a magnetic substrate affixed to a leather lamina.

### RELATED APPLICATIONS

This application claims the benefit of U.S. Provisional Application No. 60/578,285 filed on Jun. 10, 2004.

### FIELD OF THE INVENTION

The invention relates to floor coverings and wall coverings, and more particularly to leather tiles that may be used as floor or wall coverings.

### BACKGROUND OF THE INVENTION

Leather tiles have been used for floor and wall coverings for many years. Leather tiles are durable, versatile, and have an attractive appearance. Installation involves adhesion of individual tiles to a surface. Correct placement of individual leather tiles is important for the best appearance. Individual tiles must be carefully aligned, but adjustments limited within the cure period of the adhesive. Over the life of a tiled surface, some tiles may stain, or become damaged. Once adhered, tiles are difficult to remove. Removal may require rough scraping or prying to loosen tiles from the surface, which may cause damage to the surface or to the surrounding tiles. Removing individual tiles while leaving neighboring tiles in place may be impossible. Leather tiles, once removed, are typically not re-usable. Adhesive residue on the tiles or the surface may be difficult or impossible to remove. As a result of these challenges in installation and removal, leather tiles have not been suitable for temporary or portable installations, or repeated installations of the same leather tiles on different surfaces.

### SUMMARY OF THE INVENTION

The present invention has as a primary object to simplify installation, removal and replacement of wall and floor tiles.

The present invention has as a further object to permit temporary or portable installation of leather tiles.

According to a first aspect of the invention, a flexible composite tile is provided which comprises a magnetic substrate; and a leather lamina affixed to the magnetic substrate to form a tile. Preferably, the magnetic substrate and the leather lamina share a bounded edge. Preferably, the leather lamina is adhesively affixed completely to the magnetic substrate. The composite tile may be used as a floor tile or as a wall tile.

Preferably, the leather is vegetable-tanned and is of a grade and thickness similar to leather for shoe soles (“sole grade”). The leather may be dyed or colored, and may have debossed features. The composite tile preferably has a relatively thick leather lamina and a relatively thin magnetic substrate. The leather lamina may also be recycled leather (in the form of leatherboard).

In shape, the composite tile is preferably a quadrilateral, such as a square, rectangle or parallelogram.

According to a second aspect of the invention, a composite tiling system is provided, which comprises the above tile magnetically affixed to a metal underlay. The surface area of the metal underlay is preferably greater than the surface area of a tile.

### BRIEF DESCRIPTION OF THE FIGURES

FIG. 1 shows an exploded view of a composite tile according to the preferred embodiment.

FIG. 2 shows a perspective view of the preferred embodiment in laminated (finished) state.

### DETAILED DESCRIPTION

A leather tile is provided as the preferred embodiment of the composite tile. Leather is a preferred material for the tile because of leather's natural warmth, resilience and attractive appearance. As a floor or wall tile, leather requires little maintenance and can actually improve in appearance with wear. Over time, leather develops a patina over time that enhances its character and beauty. Leather also has natural color variations that add to the visual interest of a wall or floor when tiled with leather tiles. Leather has numerous desirable properties as a wall or floor covering. Leather is sound absorbing. Leather also acts as a natural fire retardant.

Leather is made from the tanned, shaved and dyed hide of animals, such as cows, pigs, and water buffaloes. Such leather is typically sourced as a by-product of the food industry. Preferably, leather tiles are made using vegetable-tanned leather, which creates a very durable and versatile leather. The main ingredient in vegetable tanning is tree bark. Alternatively, leather for tiles may be processed using other tanning techniques, such as currying. Preferably, the leather used for tiles is from the hind quarter of the animal hide (the “bends”), which provides the thickest, highest quality leather. This thick grade of leather is frequently used for shoe soles.

Preferably, the tiles are made using 100% leather pieces. However, leatherboard, which is a fabricated leather product made from recycled leather scraps, may also be used for tiles.

Leather may also be decorated with color finishes and impressed with debossings to give different color and grain characters. For instance, aniline dyes may be used, which come in a variety of colors. Wax finishes may also be used, alone, or in conjunction with dyes. Debossing involves the application of patterns into the leather using an aluminum die press with a heated element.

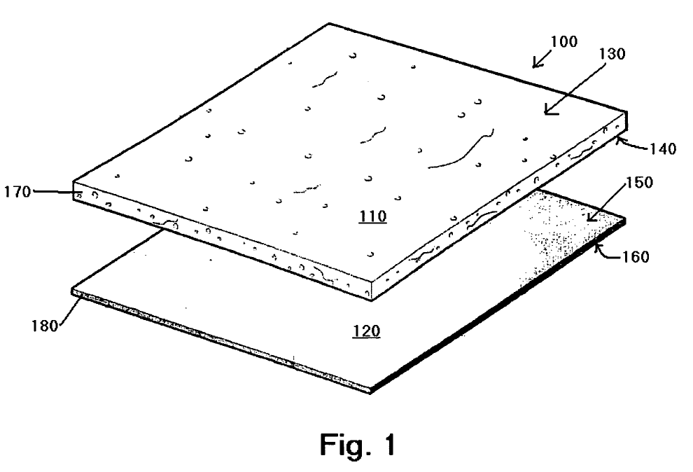

As shown in FIG. 1, each tile 100 preferably consists of a magnetic substrate 120 and a leather lamina 110. The magnetic substrate has a top surface 150 and a bottom surface 160. The top surface 150 of the magnetic substrate is preferably provided with an adhesive. The leather lamina 110 also has a top surface 130 and a bottom surface 140. The bottom surface 140 of the leather lamina is preferably laminated to the adhesive on the top surface 130 of the magnetic substrate to form the composite tile 100. This lamination process may be done by pressing the top surface 130 of the leather lamina to secure the parts together. The composite tile may undergo a final finishing cut to even the edges 170, 180. Alternatively, a large sheet of laminated leather and magnetic substrate material may be punched or cut out through both layers to produce a cut-out of tile size.

The magnetic sheeting is preferably provided with a self-adhesive layer. To adhere self-adhesive magnetic sheeting, a protective sheet is removed from the self-adhesive side, and the magnetic sheeting is simply pressed against the flesh side (suede side) of the leather to form a composite. Self-adhesive magnetic sheeting is sold, for instance, under the brand name SPEC-HDH ULTRAMAG™, which is a product of Flexmag Industries, 107 Industry Road, Marietta, Ohio, 45750. Alternatively, a latex contact cement may be brushed or rolled on the magnetic sheeting, which would then be adhered to the flesh side of the leather. To laminate the pieces, a hot rolling press is preferably used.

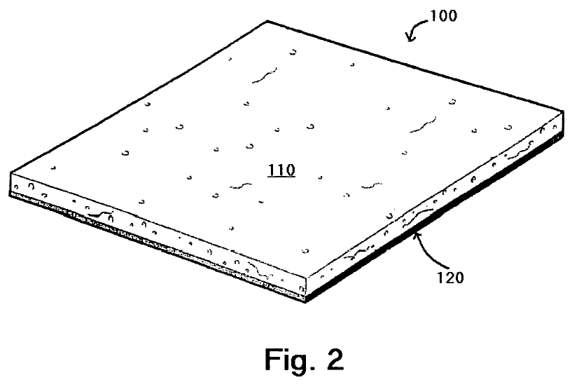

FIG. 2 shows a perspective view of a composite tile 100. Preferably, the tile has a leather lamina 110 affixed to a magnetic substrate 120. Because of its magnetic base, the composite tile 100 can be used in a myriad ways for decoration of floors and walls (not shown). In particular, the composite tiles 100 permit changing the pattern of the floor and walls. The composite tiles can also be easily installed and taken down for temporary installations, such as trade show booths. In extended or high-traffic use, worn or stained tiles can be easily removed for repair and/or replacement. The magnetic substrate 120 also alleviates the need to use adhesive or cement for securing the tile to the surface, which reduces the negative environmental impact of the product. The tiles are also re-usable, and long-wearing which reduces waste.

The flexibility of the leather lamina 110 and the magnetic substrate 120 also facilitates placement and removal of tiles. Corners and edges have some “give”, which permits greater maneuverability as the tile can be laid down or removed gradually. By “flexibility” it is meant that the tile can bend to a certain degree without folding or breaking. When bending force is removed, the tile naturally lies flat.

In use, the surface to be tiled is first provided with a metal underlay, such as a steel substrate. This metal underlay (not shown) can be temporarily or permanently attached to a permanent surface to be tiled (such as a new or existing floor or wall), or to a freestanding structure (such as a divider or a temporary wall). For instance, for wall application, the metal underlay can be secured to the wall using screws or water-based adhesives. The metal underlay holds the magnetic substrates 120 of the tiles 100 by simple magnetic attraction without the need for further adhesives. As the magnetic bond can be easily broken by hand, the tiles 100 can be easily placed, replaced and adjusted to obtain the perfect alignment. Like human skin, leather will tend to expand and contract with different atmospheric conditions (such as, in conditions of greater and lesser humidity, respectively). Tiles that “shrink” slightly (such as, in dry conditions) can be repositioned snugly together by simply moving the magnetic tiles. Patterns (or mosaic “tessellation”) of different colored tiles can also be created by simply moving tiles into the desired arrangement. Different shapes of tiles may also be combined to create eye-catching effects. For instance, right and left parallelogram tiles may be combined to form a “chevron” (A) pattern on a wall or floor. Because of the ease of removing and replacing tiles, color variations may even be done seasonally, such as inserting some red tiles for Christmas.

The tiles may be sold individually, or with metal backing squares, strips or sheets as a magnetic tiling “system”.

Tile shapes may be square, rectangular, parallelogram, or other custom shapes. Tile sizes are variable. A typical size of floor tile is 1 ft². Other sizes are possible. Standard thicknesses of leathers for tile use range between 1.5 mm and 4.5 mm. Other thicknesses are possible. Thinner leathers may be preferred for wall application. Preferably, leather for use in floor applications is at least 4 mm thick. Bulk magnetic sheeting has a standard thickness of between 1 mm and 1.5 mm. Thicker magnetic sheeting is preferred for tiles as the magnetic attraction is stronger in thicker sheeting. Preferably, the magnetic attraction is sufficiently strong that the tiles will resist slippage when installed.

The foregoing is considered as illustrative only of the principles of the invention. Further, since numerous modifications and changes will readily occur to those skilled in the art, it is not desired to limit the invention to the exact processes, materials and applications shown and described, and accordingly, all suitable modifications and equivalents may be resorted to, falling within the scope of the invention and the appended claims and their equivalents.

1. A flexible composite tile, comprising:
a magnetic substrate; and
a leather lamina affixed to the magnetic substrate to form a tile.

2. The composite tile of claim 1, wherein the magnetic substrate and the leather lamina share a bounded edge.

3. The composite tile of claim 1, wherein the leather lamina is adhesively affixed to the magnetic substrate.

4. The composite tile of claim 1, wherein the composite tile is a floor tile.

5. The composite tile of claim 1, wherein the composite tile is a wall tile.

6. The composite tile of claim 1, wherein the leather lamina comprises recycled leather.

7. The composite tile of claim 1, wherein the leather lamina comprises vegetable-tanned leather.

8. The composite tile of claim 1, wherein the leather lamina comprises sole grade leather.

9. The composite tile of claim 1, wherein the leather lamina comprises dyed or colored leather.

10. The composite tile of claim 1, wherein the leather lamina comprises debossed leather.

11. The composite tile of claim 1, wherein the composite tile is a quadrilateral shape.

12. The composite tile of claim 1, wherein the composite tile is a square.

13. The composite tile of claim 1, wherein the composite tile is a rectangle.

14. The composite tile of claim 1, wherein the composite tile is a parallelogram.

15. The composite tile of claim 1, wherein the leather lamina comprises a relatively thick layer, and the magnetic substrate comprises a relatively thin layer.

16. A composite tiling system, comprising:
a flexible composite tile, comprising:
a magnetic substrate; and
a leather lamina affixed to the magnetic substrate to form a tile; and
a metal underlay to which the tile is magnetically affixed.

17. The composite tiling system of claim 16, wherein the metal underlay comprises a larger surface area than the surface area of the tile.
